(19) United States
(12) Patent Application Publication
(10) Pub. No.: US 2025/0373406 A1
(43) Pub. Date: Dec. 4, 2025

(54) VEHICLE-MOUNTED APPARATUS AND TIME SYNCHRONIZATION METHOD

(71) Applicants: AutoNetworks Technologies, Ltd., Yokkaichi-Shi, Mie (JP); Sumitomo Wiring Systems, Ltd., Yokkaichi-shi, Mie (JP); Sumitomo Electric Industries, Ltd., Osaka-Shi, Osaka (JP)

(72) Inventors: Kazuki KITAGAWA, Yokkaichi-Shi, Mie (JP); Kazuyuki INOUE, Yokkaichi-Shi, Mie (JP); Tadashi MATSUMOTO, Yokkaichi-shi, Mie (JP)

(73) Assignees: AutoNetworks Technologies, Ltd., Yokkaichi-Shi, Mie (JP); Sumitomo Wiring Systems, Ltd., Yokkaichi-shi, Mie (JP); Sumitomo Electric Industries, Ltd., Osaka-Shi, Osaka (JP)

(21) Appl. No.: 18/876,149

(22) PCT Filed: May 29, 2023
(86) PCT No.: PCT/JP2023/019945

§ 371 Date: Dec. 17, 2024

(30) Foreign Application Priority Data
Jun. 17, 2022 (JP) 2022-098041

(51) Int. Cl. H04L 7/00; H04W 4/48

(52) U.S. Cl. CPC H04L 7/00; H04W 4/48

(57) ABSTRACT

A vehicle-mounted apparatus to be used on a vehicle-mounted network includes: a time synchronization unit configured to calculate a time difference with another vehicle-mounted apparatus by transmitting and receiving time synchronization information, which is information for time synchronization between the vehicle-mounted apparatus and the other vehicle-mounted apparatus, and to perform time synchronization with the other vehicle-mounted apparatus based on the calculated time difference; a detection unit configured to monitor first transmission information, which is information transmitted to the vehicle-mounted apparatus from the other vehicle-mounted apparatus, and to detect an abnormality in a content of the first transmission information; and an abnormality processing unit configured to perform a stop process for stopping time synchronization on the vehicle-mounted network using the time synchronization information transmitted from the other vehicle-mounted apparatus when an abnormality has been detected by the detection unit.

### CROSS-REFERENCE TO RELATED APPLICATIONS

This application is the U.S. national stage of PCT/JP2023/019945 filed on May 29, 2023, which claims priority of Japanese Patent Application No. JP 2022-098041 filed on Jun. 17, 2022, the contents of which are incorporated herein.

### TECHNICAL FIELD

The present disclosure relates to a vehicle-mounted apparatus and a time synchronization method.

### BACKGROUND

In the past, a technology was developed where the time held by a certain vehicle-mounted apparatus on a vehicle-mounted network is set as a reference time and the vehicle-mounted apparatuses on such vehicle-mounted network perform time synchronization using this reference time.

JP2020-167616A discloses the time synchronization system described below. That is, in a time synchronization system where the time at a slave is synchronized with a grandmaster clock, an apparatus that functions as the grandmaster, one or more apparatuses that function as adjacent repeaters, and one or more apparatuses that function as terminals are connected via a network. The grandmaster transmits a signal including a clock on the network, and each terminal corrects its time based on the clock, sums a time correction amount with a correction integrated value a held by that terminal and, if a exceeds a predetermined threshold, transmits a grandmaster abnormality notification message onto the network. Each adjacent repeater corrects its own time based on the clock, sums the time correction amount into the α value it holds, and if α exceeds a predetermined threshold and a grandmaster abnormality notification message has been received from one or more apparatuses under its control, transmits a message on the network indicating that a grandmaster should be reassigned.

However, if the grandmaster has been subjected to an unauthorized attack via the network, a problem may occur where synchronization of time on the vehicle-mounted network is not performed properly.

The present disclosure was conceived to solve the problem described above, and has an object of providing a vehicle-mounted apparatus and a time synchronization method capable of suppressing the occurrence of time synchronization abnormalities on a vehicle-mounted network.

### SUMMARY

According to the present disclosure, it is possible to suppress the occurrence of time synchronization abnormalities on a vehicle-mounted network.

A vehicle-mounted apparatus according to an aspect of the present disclosure is to be used on a vehicle-mounted network and includes: a time synchronization unit configured to calculate a time difference with another vehicle-mounted apparatus by transmitting and receiving time synchronization information, which is information for time synchronization between the vehicle-mounted apparatus and the other vehicle-mounted apparatus, and to perform time synchronization with the other vehicle-mounted apparatus based on the calculated time difference; a detection unit configured to monitor first transmission information, which is information transmitted to the vehicle-mounted apparatus from the other vehicle-mounted apparatus, and to detect an abnormality in a content of the first transmission information; and an abnormality processing unit configured to perform a stop process for stopping time synchronization on the vehicle-mounted network using the time synchronization information transmitted from the other vehicle-mounted apparatus when an abnormality has been detected by the detection unit.

The above aspect of the present disclosure can be realized not only as a vehicle-mounted apparatus equipped with the characteristic processing unit described above and may also be realized by a program for causing a computer to perform such characteristic processing. The above aspect of the present disclosure may be realized by a semiconductor integrated circuit that realizes part or all of the vehicle-mounted apparatus or by a system including such vehicle-mounted apparatus.

### BRIEF DESCRIPTION OF DRAWINGS

FIG. 1 depicts the configuration of a vehicle-mounted communication system according to a first embodiment of the present disclosure.

FIG. 2 depicts the configuration of a switch apparatus according to the first embodiment of the present disclosure.

FIG. 3 depicts the configuration of a master function unit according to the first embodiment of the present disclosure.

FIG. 4 is a diagram useful in explaining a method of updating a propagation delay time by a switch apparatus according to the first embodiment of the present disclosure.

FIG. 5 depicts the configuration of an end function unit according to the first

embodiment of the present disclosure.

FIG. 6 is a diagram useful in explaining a method of updating the propagation delay time by the end function unit according to the first embodiment of the present disclosure.

FIG. 7 depicts one example of a stop process performed by a switch

apparatus on the vehicle-mounted network according to the first embodiment of the present disclosure.

FIG. 8 depicts one example of a sequence of a process, which monitors time synchronization information and stops time synchronization, performed by a switch apparatus in the vehicle-mounted communication system according to the first embodiment of the present disclosure.

FIG. 9 depicts another example of a sequence of a process, which monitors the time source information and stops time synchronization, performed by a switch apparatus in the vehicle-mounted communication system according to the first embodiment of the present disclosure.

FIG. 10 depicts the configuration of a vehicle-mounted communication system according to a second embodiment of the present disclosure.

FIG. 11 depicts the configuration of a switch apparatus according to a second embodiment of the present disclosure.

FIG. 12 depicts the configuration of a master function unit according to the second embodiment of the present disclosure.

FIG. 13 depicts one example of a stop process performed by a master function unit and a switch apparatus in a vehicle-mounted communication system according to the second embodiment of the present disclosure.

FIG. 14 depicts one example of a sequence of a process, which monitors time synchronization information and switches the time synchronization information, performed by a master function unit in the vehicle-mounted communication system according to the second embodiment of the present disclosure.

FIG. 15 depicts another example of the sequence of a process, which monitors the time synchronization information and switches between time synchronization information, performed by a master function unit in the vehicle-mounted communication system according to the second embodiment of the present disclosure.

### DETAILED DESCRIPTION OF PREFERRED EMBODIMENTS

Several embodiments of the present disclosure will first be listed and described in outline.

In a first aspect, a vehicle-mounted apparatus according to an aspect of the present disclosure is used on a vehicle-mounted network and includes: a time synchronization unit configured to calculate a time difference with another vehicle-mounted apparatus by transmitting and receiving time synchronization information, which is information for time synchronization between the vehicle-mounted apparatus and the other vehicle-mounted apparatus, and to perform time synchronization with the other vehicle-mounted apparatus based on the calculated time difference; a detection unit configured to monitor first transmission information, which is information transmitted to the vehicle-mounted apparatus from the other vehicle-mounted apparatus, and to detect an abnormality in a content of the first transmission information; and an abnormality processing unit configured to perform a stop process for stopping time synchronization on the vehicle-mounted network using the time synchronization information transmitted from the other vehicle-mounted apparatus when an abnormality has been detected by the detection unit.

With this configuration, it is possible to detect an abnormality relating to another vehicle-mounted apparatus and as one example to stop in advance time synchronization using time synchronization information transmitted from such other vehicle-mounted apparatus. Accordingly, it is possible to suppress the occurrence of time synchronization abnormalities on the vehicle-mounted network.

In a second aspect, the vehicle-mounted apparatus according to the first aspect, the first transmission information may be the time synchronization information.

In this manner, by using a configuration that detects whether an abnormality has occurred in the content of the time synchronization information, it is possible to more effectively stop time synchronization with the other vehicle-mounted apparatus.

In a third aspect, the vehicle-mounted apparatus according to the first aspect, the first transmission information may indicate a source of reference information that serves as a basis for a time at the other vehicle-mounted apparatus.

In this way, by using a configuration that grasps whether an abnormality has occurred relating to the source of the reference information that serves as the basis for the time at the other vehicle-mounted apparatus, it is possible to more effectively stop time synchronization with the other vehicle-mounted apparatus. When the abnormality described above has been detected, measures such as switching the source in the vehicle-mounted apparatus network can be taken.

In a fourth aspect, the vehicle-mounted apparatus according to any one of the first through the third aspects, the abnormality processing unit may perform the stop process that notifies another vehicle-mounted apparatus, which calculates a time difference from the vehicle-mounted apparatus using the time synchronization information that is transmitted by the vehicle-mounted apparatus, that the abnormality has been detected.

In this way, by sharing the detection of an abnormality with other vehicle-mounted apparatuses on the vehicle-mounted network, it is possible to suppress the occurrence of time synchronization abnormalities between other vehicle-mounted apparatuses and this vehicle-mounted apparatus, which makes it possible to more reliably suppress the occurrence of time synchronization abnormalities on the vehicle-mounted network.

In a fifth aspect, the vehicle-mounted apparatus according to any one of the first through the fourth aspects, the abnormality processing unit may perform the stop process that stops the time synchronization by the time synchronization unit.

With this configuration, it is possible to stop time synchronization at the present vehicle-mounted apparatus, which is highly likely to be affected by transmitted information for which an abnormality has been detected. This makes it possible to more reliably suppress the occurrence of time synchronization abnormalities on the vehicle-mounted network.

In a sixth aspect, the vehicle-mounted apparatus according to any one of the first through the fifth aspects, the abnormality processing unit may perform the stop process that stops transmission of the time synchronization information to another vehicle-mounted apparatus that calculates a time difference from the vehicle-mounted apparatus using the time synchronization information transmitted by the vehicle-mounted apparatus.

In this way, by stopping the transmission of time synchronization information to another vehicle-mounted apparatus that performs time synchronization with the present vehicle-mounted apparatus, it is possible to suppress the occurrence of time synchronization abnormalities between such other vehicle-mounted apparatus and the present vehicle-mounted apparatus. This makes it possible to more reliably suppress the occurrence of time synchronization abnormalities on the vehicle-mounted network.

In a seventh aspect, the vehicle-mounted apparatus according to any one of the first through the sixth aspects, a first reference apparatus, which is the other vehicle-mounted apparatus that performs time synchronization with the vehicle-mounted apparatus, and a second reference apparatus may be provided on the vehicle-mounted network, the second reference apparatus may monitor second transmission information, which is information transmitted from the first reference apparatus to the second reference apparatus, and detect an abnormality relating to a content of the second transmission information, and when an abnormality has been detected by the second reference apparatus, the time synchronization unit may transmit and receive time synchronization information, which is information for time synchronization, with the second reference apparatus in place of the first reference apparatus, calculate a time difference from the second reference apparatus, and perform time synchronization with the second reference apparatus based on the calculated time difference.

In this way, if an abnormality relating to the first reference apparatus has been detected, the time synchronization is switched from time synchronization with the first reference apparatus to time synchronization with the second reference apparatus, which enables the present vehicle-mounted apparatus to perform time synchronization with the second reference apparatus and thereby achieve more stabilized time synchronization on the vehicle-mounted network.

In an eighth aspect, the vehicle-mounted apparatus according to any one of the first through the sixth aspects, a first reference apparatus, which is the other vehicle-mounted apparatus, and a second reference apparatus, may be provided on the vehicle-mounted network, and when an abnormality has been detected by the detection unit, the time synchronization unit may transmit and receive time synchronization information, which is information for time synchronization, with the second reference apparatus in place of the first reference apparatus, calculate a time difference from the second reference apparatus, and perform time synchronization with the second reference apparatus based on the calculated time difference.

In this way, if an abnormality relating to the first reference apparatus has been detected, the time synchronization destination is switched from the first reference apparatus to the second reference apparatus, which enables the present vehicle-mounted apparatus to perform time synchronization with the second reference apparatus and thereby achieve more stabilized time synchronization on the vehicle-mounted network.

In a ninth aspect, the vehicle-mounted apparatus according to the second aspect, the time synchronization information may be at least one of a Sync message used for time synchronization and a follow-up message.

In this way, by monitoring at least one of a Sync message, which is commonly used for time synchronization, and a follow-up message, it is possible to easily determine the presence of an abnormality by checking information indicating the ID or time stamp stored in received Ethernet frames, for example.

A time synchronization method according to an aspect of the present disclosure is a time synchronization method for a vehicle-mounted apparatus and the method includes: a step of calculating a time difference with another vehicle-mounted apparatus by transmitting and receiving time synchronization information, which is information for time synchronization between the vehicle-mounted apparatus and the other vehicle-mounted apparatus, and performing time synchronization with the other vehicle-mounted apparatus based on the calculated time difference; a step of monitoring first transmission information, which is information transmitted to the vehicle-mounted apparatus from the other vehicle-mounted apparatus, and detecting an abnormality in a content of the first transmission information; and a step of performing a stop process for stopping time synchronization on a vehicle-mounted network using the time synchronization information transmitted from the other vehicle-mounted apparatus when an abnormality has been detected.

With this method, it is possible to detect an abnormality relating to another vehicle-mounted apparatus and as one example to stop in advance time synchronization using time synchronization information transmitted from such other vehicle-mounted apparatus. Accordingly, it is possible to suppress the occurrence of time synchronization abnormalities on the vehicle-mounted network.

Preferred embodiments of the present disclosure will now be described with reference to the drawings. Note that identical and corresponding parts in the drawings have been assigned the same reference numerals, and description thereof will not be repeated. The embodiments described below may also be freely combined, at least in part.

### First Embodiment

### Vehicle-Mounted Communication System

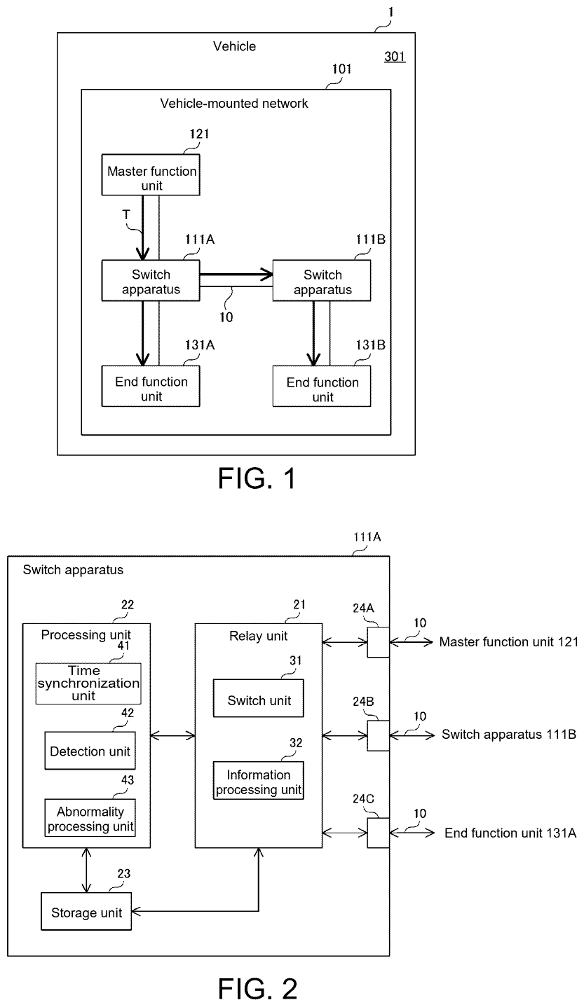

FIG. 1 depicts the configuration of a vehicle-mounted communication system according to a first embodiment of the present disclosure.

As depicted in FIG. 1, one example of a vehicle-mounted communication system 301 includes a plurality of switch apparatuses 111, one master function unit 121, and a plurality of end function units 131.

In FIG. 1, two switch apparatuses 111A and 111B and two end function units 131A and 131B are depicted as one example of the plurality of switch apparatuses 111 and the plurality of end function units 131. The vehicle-mounted communication system 301 is mounted in a vehicle 1. The switch apparatuses 111, the master function unit 121, and the end function units 131 construct a vehicle-mounted network 101.

The switch apparatuses 111, the master function unit 121 and the end function unit 131 are examples of “vehicle-mounted apparatuses”, and as one example are ECUs (Electronic Control Units).

Each switch apparatus 111 is connected to a plurality of vehicle-mounted apparatuses via an Ethernet (registered trademark) cable 10, for example, and is capable of communicating with the plurality of vehicle-mounted apparatuses connected to that switch apparatus 111.

In more detail, each switch apparatus 111 performs a relaying process to relay information from the master function unit 121 or one end function unit 131 to another end function unit 131. As one example, a switch apparatus 111 receives information for time synchronization (hereinafter also referred to as the “time synchronization information T”) that has been transmitted from the master function unit 121 and transmits the received time synchronization information T to another switch apparatus 111 or an end function unit 131.

Information may be exchanged between each switch apparatus 111 and the master function unit 121, and between each switch apparatus 111 and each end function unit 131 using Ethernet frames (hereinafter simply referred to as “frames”) that store IP (Internet Protocol) packets, for example.

As examples, the master function unit 121 and the end function units 131 may be an external communication ECU, a sensor, a vehicle-mounted camera, a navigation apparatus, an autonomous driving processing ECU, an engine control device, an AT (Automatic Transmission) control device, an HEV (Hybrid Electric Vehicle) control device, a brake control device, a chassis control device, a steering control device, or an instrument display control device.

The master function unit 121 (hereinafter also referred to as “GM (Grand Master)”) holds a reference time for the vehicle-mounted network 101. Here, as one example, the reference time is a time generated by the master function unit 121 using a VCXO (Voltage Controlled Xtal Oscillator) and a counter, not illustrated. Note that, as described later, the reference time may be a time that has been synchronized with a time indicated to the master function unit 121 by another apparatus. The master function unit 121 regularly or irregularly transmits the time synchronization information T to other vehicle-mounted apparatuses. The master function unit 121 transmits the time synchronization information T at a transmission cycle of 125 milliseconds, for example. Here, as examples, the time synchronization information T is a Sync message and a follow-up message, which will be described later.

Each vehicle-mounted apparatus in the vehicle-mounted communication system 301 receives the time synchronization information T, which is one example of transmission information (hereinafter also referred to as “first transmission information”) transmitted from the master function unit 121.

In more detail, the switch apparatus 111A receives the time synchronization information T directly from the master function unit 121. The switch apparatus 111B receives this time synchronization information T via the switch apparatus 111A.

The end function unit 131A receives the time synchronization information T via the switch apparatus 111A. The end function unit 131B receives the time synchronization information T via the switch apparatuses 111A and 111B.

The switch apparatuses 111 perform time synchronization with the master function unit 121 based on the time synchronization information T. In more detail, each switch apparatus 111 calculates the time difference with the master function unit 121 using the time synchronization information T transmitted by the master function unit 121. Each switch apparatus 111 corrects its own time using the calculated time difference.

Each end function unit 131 performs time synchronization with a switch apparatus 111 based on the time synchronization information T. In more detail, each end function unit 131 calculates the time difference with a switch apparatus 111 using the time synchronization information T transmitted by that switch apparatus 111. The end function unit 131 corrects its own time using the calculated time difference.

### Switch Apparatus and Master Function Unit

### Configuration of Switch Apparatus

FIG. 2 depicts the configuration of a switch apparatus according to the first embodiment of the present disclosure. FIG. 2 depicts the configuration of the switch apparatus 111A.

As depicted in FIG. 2, the switch apparatus 111A includes a relay unit 21, a processing unit 22, a storage unit 23, and a plurality of communication ports 24.

As one example, one or both of the relay unit 21 and the processing unit 22 are realized by a processing circuit (or “circuitry”) including one or a plurality of processors. As one example, the storage unit 23 is a non-volatile memory included in such processing circuit. The relay unit 21 includes a switch unit 31 and an information processing unit 32. The processing unit 22 includes a time synchronization unit 41, a detection unit 42, and an abnormality processing unit 43.

### Relay Processing by Switch Apparatus

Each communication port 24 is a terminal to which an Ethernet cable 10 can be connected, for example. These communication ports 24 may be terminals of an integrated circuit. Each of the plurality of communication ports 24 is connected via an Ethernet cable 10 to one out of the plurality of vehicle-mounted apparatuses on the vehicle-mounted network 101. In this example, the communication port 24A is connected to the master function unit 121, the communication port 24B is connected to the switch apparatus 111B, and the communication port 24C is connected to the end function unit 131A.

The storage unit 23 stores an address table indicating the correspondence between port numbers of the communication ports 24 and the MAC (Media Access Control) addresses of connected apparatuses.

The relay unit 21 relays data to and from other vehicle-mounted apparatuses by communicating with such other vehicle-mounted apparatuses. That is, when the relay unit 21 receives an Ethernet frame transmitted from the master function unit 121 or an end function unit 131 via the corresponding communication port 24, the relay unit 21 performs relay processing for the received Ethernet frame.

In more detail, the switch unit 31 in the relay unit 21 refers to the address table stored in the storage unit 23 and specifies a port number corresponding to a destination MAC address included in the received Ethernet frame. The switch unit 31 then transmits the received Ethernet frame from the communication port 24 with the specified port number.

The time synchronization unit 41 performs time synchronization between the switch apparatus 111, that is, the vehicle-mounted apparatus equipped with the time synchronization unit 41 (hereinafter also referred to as “the present apparatus”), and the master function unit 121, which is another vehicle-mounted apparatus. In more detail, the time synchronization unit 41 transmits and receives the time synchronization information T between the switch apparatus 111 and the master function unit 121. The time synchronization unit 41 then calculates a time difference between the time at this switch apparatus 111 and the time at the master function unit 121, and performs time synchronization with the master function unit 121 based on this calculated time difference. Note that the functions of the detection unit 42 and the abnormality processing unit 43 will be described later. Although the configuration of the switch apparatus 111A has been described as an example in FIG. 2, as one example, the switch apparatus 111B may have the same configuration as the switch apparatus 111A. Note that it is also possible to realize the switch apparatus 111B without including the detection unit 42 and the abnormality processing unit 43, described later.

### Configuration of Master Function Unit

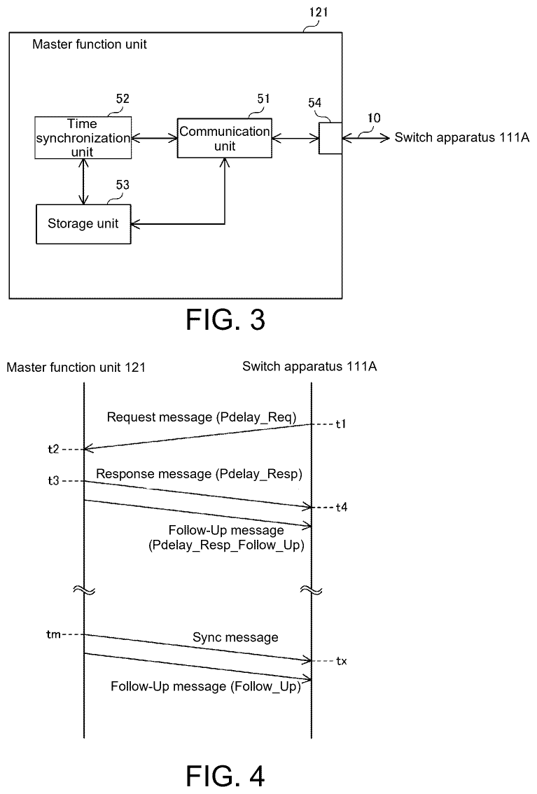

FIG. 3 depicts the configuration of a master function unit according to the first embodiment of the present disclosure.

As depicted in FIG. 3, the master function unit 121 includes a communication unit 51, a time synchronization unit 52, a storage unit 53, and a communication port 54. One or both of the communication unit 51 and the time synchronization unit 52 are realized by a processing circuit including one or a plurality of processors for example. The storage unit 53 is a non-volatile memory included in such processing circuit for example. The communication port 54 is a terminal to which an Ethernet cable 10 can be connected, for example. Note that the communication port 54 may be a terminal of an integrated circuit or the like. The communication port 54 is connected via the Ethernet cable 10 to the switch apparatus 111A.

FIG. 4 is a diagram useful in explaining a method of updating a propagation delay time by a switch apparatus according to the first embodiment of the present disclosure.

As depicted in FIGS. 2 to 4, the switch apparatus 111A updates a propagation delay time Td1 for data between the master function unit 121 and the switch apparatus 111A by transmitting and receiving time synchronization information T between the master function unit 121 in accordance with the IEEE (registered trademark) 802.1 Standard, for example. In more detail, the time synchronization unit 41 transmits request information (Pdelay_Req), which requests time information to be used to update the propagation delay time Td1, to the master function unit 121 via the relay unit 21 and the communication port 24A. Hereinafter, this request information is also referred to as a “request message.”

The communication unit 51 in the master function unit 121 receives the request message transmitted from the switch apparatus 111A via the communication port 54, and outputs the received request message to the time synchronization unit 52.

The time synchronization unit 52 receives the request message from the communication unit 51 and outputs time information (Pdelay_Resp), which is one example of the time synchronization information T, in response to the request message to the communication unit 51. The communication unit 51 transmits the time information received from the time synchronization unit 52 via the communication port 54 to the switch apparatus 111A. When this is performed, the time synchronization unit 52 transmits the time information including the reception time t2 of the request message. Hereinafter, this time information is also referred to as the “response message”.

After transmitting the response message, the time synchronization unit 52 outputs a follow-up message (Pdelay_Resp_Follow_Up), which includes the transmission time t3 of the response message, to the communication unit 51. The communication unit 51 transmits the follow-up message received from the time synchronization unit 52 via the communication port 54 to the switch apparatus 111A.

The information processing unit 32 in the switch apparatus 111A receives the response message and the follow-up message transmitted from the master function unit 121 via the communication port 24A. The information processing unit 32 then notifies the time synchronization unit 41 of the time t2 included in the response message and the time t3 included in the follow-up message.

The information processing unit 32 also notifies the time synchronization unit 41 of the transmission time t1 of the request message and the reception time t4 of the response message. In more detail, the switch apparatus 111A includes a counter, not illustrated. The information processing unit 32 notifies the time synchronization unit 41 of the count value of the counter at the transmission timing of the request message as the transmission time t1. The information processing unit 32 also notifies the time synchronization unit 41 of the count value of the counter at the reception timing of the response message as the reception time t4.

The time synchronization unit 41 calculates the propagation delay time Td1 of data between the master function unit 121 and the switch apparatus 111A based on the times t1, t2, t3, and t4 indicated by the information processing unit 32. In more detail, the time synchronization unit 41 calculates the propagation delay time Td1=((t4−t1)−(t3−t2))/2. The time synchronization unit 41 then updates the propagation delay time Td1 stored in the storage unit 23 to the newly calculated propagation delay time Td1.

### Time Correction at Switch Apparatus

The time synchronization unit 52 of the master function unit 121 regularly or irregularly outputs a Sync message, which is one example of the time synchronization information T, to the communication unit 51. The communication unit 51 transmits the Sync message received from the time synchronization unit 52 via the communication port 54 to the switch apparatus 111A. The master function unit 121 transmits the Sync message with a transmission cycle of 125 milliseconds, for example.

After transmitting the Sync message, the time synchronization unit 52 of the master function unit 121 outputs the follow-up message (Follow_Up), which includes the transmission time tm of the Sync message, to the communication unit 51. The communication unit 51 transmits the follow-up message received from the time synchronization unit 52 via the communication port 54 to the switch apparatus 111A.

The time synchronization unit 41 of the switch apparatus 111A receives a frame in which the Sync message is stored and a frame in which the follow-up message is stored that have been transmitted from the master function unit 121 via the communication port 24A. The time synchronization unit 41 then stores the Sync message stored in the received frame in the storage unit 23, for example.

The information processing unit 32 also checks the transmission source of the received frames, for example, by referring to the domain IDs included in the message headers of the frames.

In addition, when the information processing unit 32 has confirmed that the frame in which the Sync message is stored was received from the master function unit 121 that is the GM, the information processing unit 32 notifies the time synchronization unit 52 of the count value of the counter at the reception timing of that frame as the reception time tx of the Sync message.

The time synchronization unit 41 performs time synchronization with the master function unit 121 based on the times tm and tx indicated from the information processing unit 32 and the propagation delay time Td1 stored in the storage unit 23. In more detail, based on the times tm, tx and the propagation delay time Td1, the time synchronization unit 41 calculates the time difference Tx1=tm−Td1−tx between the time at the master function unit 121 and the time at the switch apparatus 111A.

The time synchronization unit 52 then corrects the time at the present switch apparatus 111A using the calculated time difference Tx1. As a result of this, time synchronization is established between the master function unit 121 that is the GM and the switch apparatus 111A.

### End Function Unit

### Configuration of End Function Unit

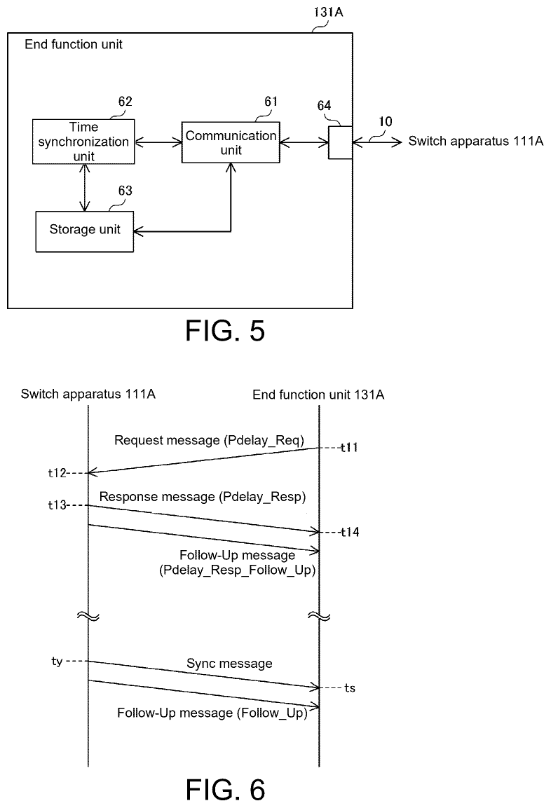

FIG. 5 depicts the configuration of an end function unit according to the first embodiment of the present disclosure. FIG. 5 depicts the configuration of the end function unit 131A. The configuration of the end function unit 131B is the same as the configuration of the end function unit 131A.

As depicted in FIG. 5, the end function unit 131A includes a communication unit 61, a time synchronization unit 62, a storage unit 63, and a communication port 64. One or both of the communication unit 61 and the time synchronization unit 62 are realized by a processing circuit including one or a plurality of processors for example. The storage unit 63 is a non-volatile memory included in such processing circuit for example. The communication port 64 is a terminal to which an Ethernet cable 10 can be connected, for example. The communication port 64 may be a terminal of an integrated circuit or the like. The communication port 64 is connected via the Ethernet cable 10 to the switch apparatus 111A.

### Updating of Propagation Delay Time for Data Between Switch Apparatus and End Function Unit

The end function unit 131A updates a propagation delay time Td2 for data between the switch apparatus 111A and the end function unit 131A.

FIG. 6 is a diagram useful in explaining a method of updating the propagation delay time by the end function unit according to the first embodiment of the present disclosure.

In more detail, by referring to FIGS. 5 and 6, the time synchronization unit 62 of the end function unit 131A updates the propagation delay time Td2 of data between the switch apparatus 111A and the end function unit 131A regularly or irregularly in the same way as the time synchronization unit 41 of the switch apparatus 111A depicted in FIG. 2. In more detail, the time synchronization unit 62 transmits a request message for requesting time information to be used to update the propagation delay time Td2 via the communication unit 61 and the communication port 64 to the switch apparatus 111A.

When the information processing unit 32 of the switch apparatus 111A has received this request message transmitted from the end function unit 131A via the communication port 24C, the information processing unit 32 outputs the request message to the time synchronization unit 41.

When the time synchronization unit 41 has received the request message from the information processing unit 32, the time synchronization unit 41 transmits a response message to this request message via the relay unit 21 and the communication port 24C to the end function unit 131A. When this is performed, the time synchronization unit 41 transmits the response message including a reception time t12 of the request message.

After transmitting the response message, the time synchronization unit 41 transmits a follow-up message including the transmission time t13 of this response message via the relay unit 21 and the communication port 24C to the end function unit 131A.

The communication unit 61 of the end function unit 131A receives the response message and the follow-up message transmitted from the switch apparatus 111A via the communication port 64. The communication unit 61 then notifies the time synchronization unit 62 of the time t12 included in the response message and the time t13 included in the follow-up message.

The communication unit 61 also notifies the time synchronization unit 62 of the transmission time t11 of the request message and the reception time t14 of the response message. In more detail, the end function unit 131A includes a counter, not illustrated. The communication unit 61 notifies the time synchronization unit 62 of the count value of the counter at the transmission timing of the request message as the transmission time t11. The communication unit 61 also notifies the time synchronization unit 62 of the count value of the counter at the timing of reception of the response message as the reception time t14.

The time synchronization unit 62 calculates the propagation delay time Td2 of data between the switch apparatus 111A and the end function unit 131A based on the times t11, t12, t13, and t14 indicated by the communication unit 61. In more detail, the time synchronization unit 62 calculates the propagation delay time Td2=((t14−t11)−(t13−t12))/2. The time synchronization unit 62 then updates the propagation delay time Td2 stored in the storage unit 63 to the newly calculated propagation delay time Td2.

### Time Correction at End Function Unit

The time synchronization unit 41 at the switch apparatus 111A regularly or irregularly transmits a Sync message to the end function unit 131A. After transmitting the Sync message, the time synchronization unit 41 also transmits a follow-up message including the transmission time ty of the Sync message to the end function unit 131A.

The end function unit 131A performs time synchronization based on the Sync message and the follow-up message transmitted from the switch apparatus 111A. In more detail, the communication unit 61 of the end function unit 131A receives, via the communication port 64, a frame in which the Sync message transmitted from the switch apparatus 111A is stored and a frame in which the follow-up message is stored. The communication unit 61 then checks the transmission source of the frames by referring for example to the domain ID included in the message header of the frame in which the received Sync message is stored.

When the communication unit 61 has confirmed that the frame in which the Sync message is stored was received from the master function unit 121 that is the GM, the communication unit 61 notifies the time synchronization unit 62 of the time ty included in the follow-up message received immediately after such frame, for example. The communication unit 61 also notifies the time synchronization unit 62 of the count value of the counter at the timing of reception of the Sync message stored in that frame as the reception time ts of the Sync message.

The time synchronization unit 62 performs time synchronization with the switch apparatus 111A based on the times ty and ts indicated from the communication unit 61 and the propagation delay time Td2 stored in the storage unit 63. In more detail, the time synchronization unit 62 calculates the time difference Tx2=ty−Td2−ts, which is the difference between the time at the switch apparatus 111A and the time at the end function unit 131A. The time synchronization unit 62 then corrects the time at the end function unit 131A to which it belongs using the calculated time difference Tx2.

Here, when time synchronization has been established between the master function unit 121 and the switch apparatus 111A, the time ty included in the follow-up message transmitted from the switch apparatus 111A to the end function unit 131A will be time that has been synchronized with the master function unit 121. This means that by having the time synchronization unit 62 of the end function unit 131A perform time correction, time synchronization is established between the end function unit 131A and the switch apparatus 111A. As a result of this, time synchronization between the end function unit 131A and the master function unit 121 is established.

The switch apparatus 111B and the end function unit 131B establish time synchronization with the master function unit 121 that is the GM in the same way as the switch apparatus 111A and the end function unit 131A.

### Description of Problems

However, if the master function unit 121 depicted in FIG. 1 is subjected to an unauthorized attack from inside or outside the vehicle 1 and is not able to recognize the reference time, there is the risk that time synchronization will not be performed properly between the plurality of vehicle-mounted apparatuses.

If the reference time held in the master function unit 121 has been tampered with by an unauthorized attack, there is also the risk of the vehicle-mounted communication system 301 not operating normally. For example, if the two end function units 131A and 131B depicted in FIG. 1 are vehicle-mounted cameras that are mounted on the front and rear of the vehicle 1, there is the risk that tampering with the reference time will cause a discrepancy in the images between the end function units 131A and 131B.

In addition, if the master function unit 121 is subjected to an unauthorized attack and an abnormality occurs in the content of the time synchronization information T, there is the risk of the absolute value of the time difference between a plurality of vehicle-mounted apparatuses increasing and the vehicle-mounted communication system 301 not operating properly.

In response to this, the switch apparatuses 111 on the vehicle-mounted network 101 according to the first embodiment of the present disclosure solves the problems described above through use of the configuration and operations described below.

### Detection of Anomalies in Content of Time Synchronization Information

The detection unit 42 in the switch apparatus 111A depicted in FIG. 2 monitors the transmission information transmitted from the master function unit 121 to the switch apparatus 111A to which it belongs and detects an abnormality in the content of the transmission information (hereinafter also referred to as the “abnormality E1”). The abnormality E1 is an abnormality relating to the content of the time synchronization information T, which is one example of the transmission information. As one example, the time synchronization information T is at least one of a Sync message used for time synchronization and a follow-up message. Note that the time synchronization information T is not limited to the Sync message and the follow-up message and may be another message used for time synchronization. The detection unit 42 outputs information indicating the detection result to the abnormality processing unit 43.

When the detection unit 42 has detected an abnormality E1, the abnormality processing unit 43 performs a stop process for stopping time synchronization using the time synchronization information T transmitted from the master function unit 121.

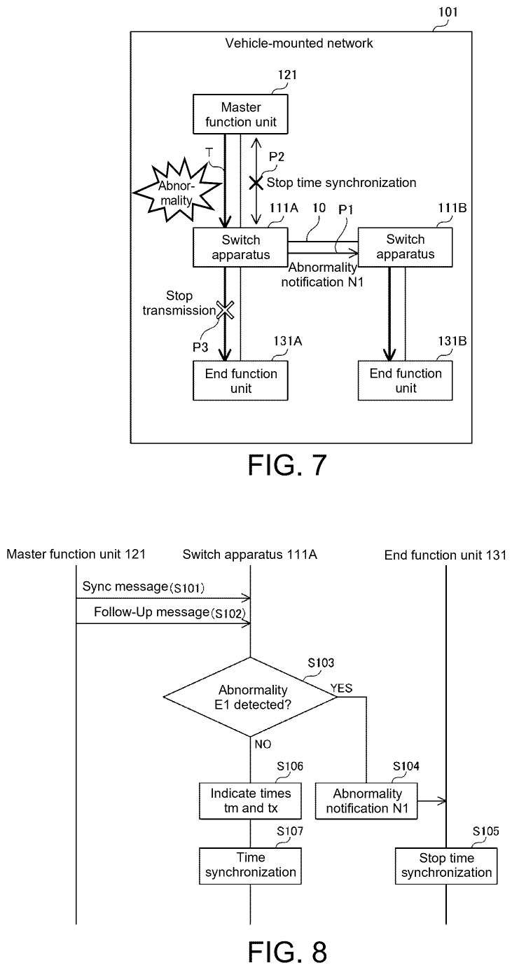

FIG. 7 depicts one example of a stop process performed by a switch apparatus on the vehicle-mounted network according to the first embodiment of the present disclosure.

As depicted in FIGS. 2, 5 and 7, when an abnormality E1 has been detected by the detection unit 42, the abnormality processing unit 43 of the switch apparatus 111A performs a stop process P1 to notify the end function unit 131 that perform time synchronization with the switch apparatus 111A to which the abnormality processing unit 43 belongs that the abnormality E1 has been detected. In more detail, when an abnormality E1 has been detected, the abnormality processing unit 43 may transmit a notification (hereinafter also referred to as the “abnormality notification N1”) indicating that the abnormality E1 has been detected via the relay unit 21 and the communication port 24 to the end function unit 131. Here, the abnormality processing unit 43 transmits the abnormality notification N1 to the end function unit 131B via the switch apparatus 111B. Note that the abnormality processing unit 43 may also transmit the abnormality notification N1 to the end function unit 131A.

As one example, after receiving the abnormality notification N1, the communication unit 61 in the end function unit 131 discards the time synchronization information T received from the switch apparatus 111A and does not store the time synchronization information T in the storage unit 63. As a result of this, the time synchronization information T is not outputted from the communication unit 61 to the time synchronization unit 62, and time synchronization between the end function unit 131 and the switch apparatus 111A is stopped.

Note that the abnormality processing unit 43 of the switch apparatus 111A may also transmit the abnormality notification N1 to the master function unit 121. After receiving the abnormality notification N1, the master function unit 121 may stop transmission of the time synchronization information T to the switch apparatus 111A, for example. As a result of this, time synchronization between the switch apparatus 111A and the master function unit 121 will stop.

When an abnormality E1 has been detected, the abnormality processing unit 43 of the switch apparatus 111A may perform a stop process for the time synchronization unit 41, that is to say, a stop process P2 that stops synchronization of time with the master function unit 121. In more detail, when an abnormality E1 has been detected, the abnormality processing unit 43 outputs the abnormality notification N1 to the relay unit 21. After receiving the abnormality notification N1, the relay unit 21 discards the time synchronization information T received via the communication port 24A from the master function unit 121 and does not store such time synchronization information T in the storage unit 23. As a result of this, the time synchronization information T is not outputted from the relay unit 21 to the time synchronization unit 41, and time synchronization between the switch apparatus 111A and the master function unit 121 is stopped.

When an abnormality E1 has been detected, the abnormality processing unit 43 of the switch apparatus 111A may perform a stop process P3 that stops the transmission of the time synchronization information T to the end function unit 131. In more detail, as described above, after receiving the abnormality notification N1 from the abnormality processing unit 43, the relay unit 21 discards the time synchronization information T received via the communication port 24A from the master function unit 121 and does not store the time synchronization information T in the storage unit 23. As a result of this, the time synchronization information T is not transmitted from the relay unit 21 via the communication port 24C to the end function unit 131, and time synchronization between the end function unit 131 and the switch apparatus 111A is stopped.

### Operation Flow

FIG. 8 depicts one example of a sequence of a process, which monitors time synchronization information and stops time synchronization, performed by a switch apparatus in the vehicle-mounted communication system according to the first embodiment of the present disclosure.

As depicted in FIG. 8, first, the master function unit 121 transmits a Sync message to the switch apparatus 111A (step S101).

The master function unit 121 then transmits a follow-up message that includes the transmission time tm of the Sync message as a time stamp (step S102).

Next, the detection unit 42 of the switch apparatus 111A performs a detection process to detect the abnormality E1.

In more detail, the detection unit 42 determines, for a string of sequentially received Sync messages, whether the sequence IDs included in the header parts of the frames in which the Sync messages are stored are consecutive. If the sequence IDs are not consecutive, the detection unit 42 detects an abnormality in the Sync messages as the abnormality E1. Note that the detection unit 42 is not limited to using the sequence IDs and may detect the abnormality E1 based on other information included in the frames in which Sync messages are stored, such as whether the domain IDs are consecutive. As one example, the detection unit 42 may also detect the abnormality E1 based on an abnormality in the order of the time stamps included in the follow-up messages (step S103).

Next, when the detection unit 42 has detected the abnormality E1 (“YES” in step S103), the abnormality processing unit 43 of the switch apparatus 111A transmits the abnormality notification N1 to the end function unit 131. As one example, this abnormality notification N1 is transmitted independently of the Sync message and the follow-up message that are transmitted from the switch apparatus 111 to the end function unit 131. Note that the abnormality notification N1 may be included in the frame in which the Sync message is stored or the frame in which the follow-up message is stored (step S104).

After this, the end function unit 131 performs a process of stopping time synchronization with the switch apparatus 111A, that is, a process of stopping time synchronization by the time synchronization unit 62 (step S105).

On the other hand, if the detection unit 42 has not detected the abnormality E1 (“NO” in step S103), the information processing unit 32 of the switch apparatus 111A receives the Sync message and the follow-up message from the master function unit 121 via the communication port 24A and notifies the time synchronization unit 41 of the time tm (see FIG. 4) included in the follow-up message and the reception time tx of the Sync message (step S106).

Next, the time synchronization unit 41 calculates the time difference Tx1 described earlier based on the times tm and tx indicated from the information processing unit 32 and the propagation delay time Td1 stored in the storage unit 23.

The time synchronization unit 41 then corrects the time at the switch apparatus 111A to which it belongs using the calculated time difference Tx1. As a result of this, it is possible for the switch apparatus 111A to perform time synchronization with the master function unit 121 (step S107).

In this way, the switch apparatus 111 can detect the abnormality E1 which relates to the master function unit 121 and stop in advance any time synchronization that uses the time synchronization information T transmitted from that master function unit 121. Accordingly, the occurrence of an abnormality in synchronization of time on the vehicle-mounted network 101 can be suppressed.

### Other Example Configuration of End Function Unit

The vehicle-mounted communication system 301 is not limited to a configuration where the detection unit 42 and the abnormality processing unit 43 are provided in the switch apparatuses 111 and may be a configuration where the detection unit 42 and the abnormality processing unit 43 are provided in the end function units 131. In other words, each end function unit 131 may have a function of monitoring the time synchronization information T.

### Other Example of Abnormality E1

In the example described above, each switch apparatus 111 detects an abnormality in the content of the time synchronization information T, which is one example of transmitted information, as the abnormality E1. In the following example, the master function unit 121 stores a time value, which has been regularly or irregularly indicated from another apparatus, as the reference time. In more detail, the master function unit 121 may hold for example a time that has been synchronized with a time value indicated by GPS (Global Positioning System) and a navigation apparatus or the like as the reference time, and may transmit transmission information (hereinafter also referred to as “time source information”), which indicates the source of the reference information that forms the basis of the time at the master function unit 121, to the switch apparatuses 111. In this case, the detection unit 42 of the switch apparatus 111 may monitor the time source information and detect an abnormality relating to the content of the time source information as the abnormality E1. Note that in the following description, an apparatus that notifies the master function unit 121 of the time is also referred to as a “time notification apparatus”.

Referring again to FIG. 2, the MAC address or IP address (hereinafter also referred to as the “reference address”) of the time notification apparatus is stored in advance in the storage unit 23 of the switch apparatus 111. As one example, the time source information transmitted from the master function unit 121 also includes the reference address of the time notification apparatus. Here, as one example, the detection unit 42 compares the reference address included in the time source information received from the master function unit 121 with the reference address stored in the storage unit 23. If the reference address included in the time source information differs from the reference address stored in the storage unit 23, the detection unit 42 determines that the abnormality E1 has occurred.

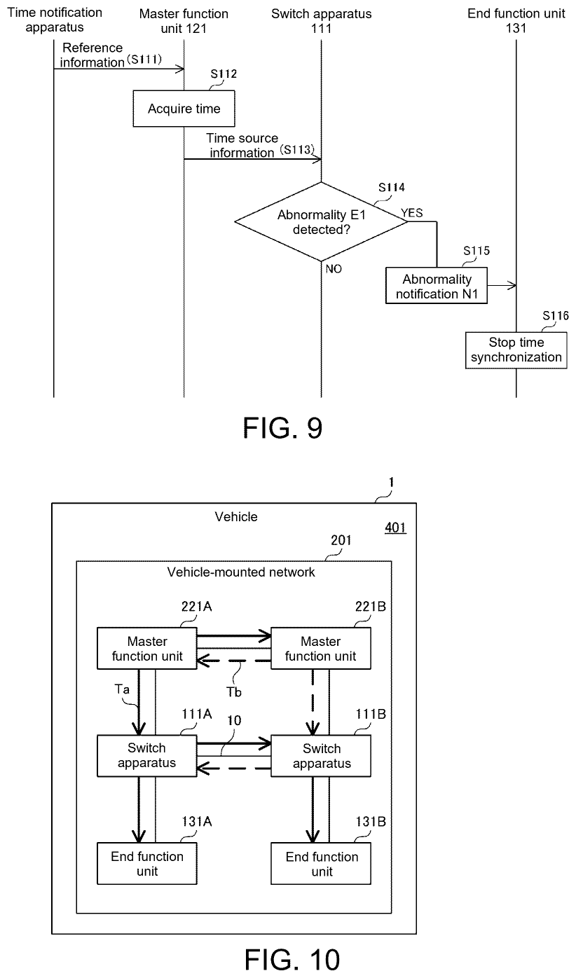

FIG. 9 depicts another example of a sequence of a process, which monitors the time source information and stops time synchronization, performed by a switch apparatus in the vehicle-mounted communication system according to the first embodiment of the present disclosure.

As depicted in FIG. 9, first, the time notification apparatus transmits time information indicating the current time at the time notification apparatus, that is, reference information on which the time of the master function unit 121 is based, to the master function unit 121 (step S111).

Next, the master function unit 121 updates the value of the counter described earlier based on, for example, the reference information. As a result of this, the master function unit 121 can acquire the time at the master function unit 121 based on the reference information provided from the time notification apparatus (step S112).

After this, the master function unit 121 transmits the time source information to the switch apparatus 111 (step S113).

Next, the detection unit 42 of the switch apparatus 111 performs a detection process to detect the abnormality E1 (step S114).

When the detection unit 42 has detected the abnormality E1 (“YES” in step S114), the abnormality processing unit 43 of the switch apparatus 111A transmits the abnormality notification N1 for stopping time synchronization to the end function unit 131 (step S115).

Next, the end function unit 131 performs a process of stopping the time synchronization with the switch apparatus 111A, that is, a process of stopping time synchronization by the time synchronization unit 62 (step S116).

On the other hand, if the detection unit 42 has not detected the abnormality E1 (“NO” in step S114), the abnormality processing unit 43 does not transmit the abnormality notification N1 to the end function unit 131.

Next, other embodiments of the present disclosure will be described with reference to the drawings. In the drawings, the same or corresponding parts have been assigned the same reference numerals and description of such parts will not be repeated.

### Second Embodiment

Compared with the vehicle-mounted communication system 301 according to the first embodiment, the present embodiment relates to a vehicle-mounted communication system 401 that includes a plurality of master function units 221A and 221B that monitor each other's time synchronization information Ta and Tb. Aside from the content described below, the vehicle-mounted communication system 401 is the same as the vehicle-mounted communication system 301 according to the first embodiment.

### Vehicle-Mounted Communication System

FIG. 10 depicts the configuration of a vehicle-mounted communication system according to the second embodiment of the present disclosure.

As depicted in FIG. 10, as one example, the vehicle-mounted communication system 401 includes a plurality of switch apparatuses 211, a plurality of master function units 221, and a plurality of end function units 131.

In FIG. 10, two master function units 221A and 221B provided on a vehicle-mounted network 201 are depicted as one example of a plurality of master function units 221. The vehicle-mounted communication system 401 is mounted in the vehicle 1. The switch apparatuses 111, the master function units 221, and the end function units 131 construct the vehicle-mounted network 201.

The two master function units 221A and 221B are connected to each other by an Ethernet cable 10 for example and are therefore each capable of communicating with the other master function unit that has been connected. The master function unit 221A is an example of a “first master apparatus” for the present disclosure and the master function unit 221B is an example of a “second master apparatus” for the present disclosure.

Hereinafter, the time synchronization information transmitted from the master function unit 221A will be referred to as “time synchronization information Ta” and the time synchronization information transmitted from the master function unit 221B will be referred to as “time synchronization information Tb”. A Sync message and a follow-up message, which are examples of the time synchronization information Ta, will be referred to as the “first Sync message” and the “first follow-up message,” respectively. Likewise, a Sync message and a follow-up message, which are examples of the time synchronization information Ta, will be referred to as the “second Sync message” and the “second follow-up message,” respectively.

Each of the master function units 221A and 221B holds the reference time for the vehicle-mounted network 201. The master function unit 221A regularly or irregularly transmits the time synchronization information Ta to the master function unit 221B and the switch apparatuses 111. The master function unit 221B regularly or irregularly transmits the time synchronization information Tb to the master function unit 221A and the switch apparatuses 111.

Each switch apparatus 111 receives both the time synchronization information Ta from the master function unit 221A and the time synchronization information Tb from the master function unit 221B. In more detail, the switch apparatus 111A receives the time synchronization information Ta directly from the master function unit 221A and receives the time synchronization information Tb via the switch apparatus 111B. The switch apparatus 111B receives the time synchronization information Tb directly from the master function unit 221B and receives the time synchronization information Ta via the switch apparatus 111A.

The end function unit 131A receives the time synchronization information Ta directly from the switch apparatus 111A. The end function unit 131B receives the time synchronization information Ta via the switch apparatus 111A and the switch apparatus 111B.

In this way, in the present embodiment, the second transmission information, which is information transmitted from the master function unit 221A to the master function unit 221B, is the same time synchronization information Ta as the first transmission information transmitted from the master function unit 221A to the switch apparatuses 111A and 111B, for example. Note that the second transmission information may be information that differs from the first transmission information. As one example, the second transmission information may be time source information indicating the source of the time of the master function unit 221.

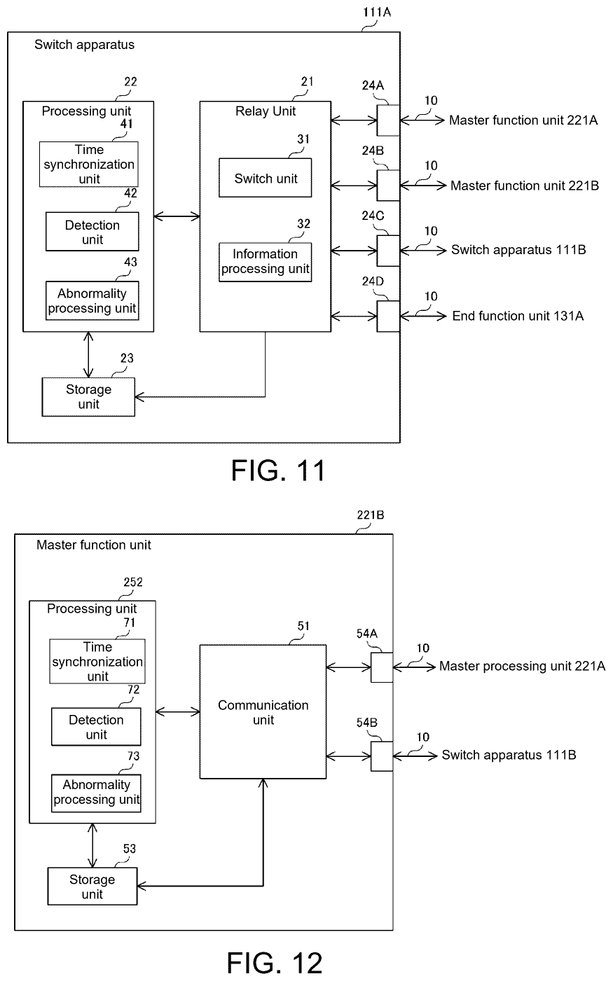

FIG. 11 depicts the configuration of a switch apparatus according to a second embodiment of the present disclosure. In comparison with the switch apparatus 111A depicted in FIG. 2A, the switch apparatus 111A depicted in FIG. 11 further includes a communication port 24D.

In FIG. 11, the communication port 24A is connected to the master function unit 221A, the communication port 24B is connected to the master function unit 221B, the communication port 24C is connected to the switch apparatus 111B, and the communication port 24D is connected to the end function unit 131A.

The switch apparatuses 111 each identify the time synchronization information to be used for time synchronization during normal operation on the vehicle-mounted network 201. As one example, each switch apparatus 111 checks the domain IDs attached to the header parts of the frame in which the first follow-up message is stored and the frame in which the second follow-up message is stored. Here, the storage unit 23 of each switch apparatus 111 stores a domain ID (hereinafter also referred to as the “normal domain ID”) of time synchronization information used for time synchronization during normal operation on the vehicle-mounted network 201. Each switch apparatus 111 checks which of the two checked domain IDs matches the normal domain ID. As a result of this, each switch apparatus 111 can determine the time synchronization information to be used for time synchronization during normal operation on the vehicle-mounted network 201. Here, it is assumed that time synchronization during normal operation is performed based on the time synchronization information Ta. In FIG. 10, the switch apparatuses 111 transmit the time synchronization information Ta to the end function units 131.

FIG. 12 depicts the configuration of a master function unit according to the second embodiment of the present disclosure. FIG. 12 depicts the configuration of the master function unit 221B. The configuration of the master function unit 221A is the same as the configuration of the master function unit 221B.

In more detail, a case will be described where the master function unit 221B performs time synchronization with the master function unit 221A. In this case, the master function unit 221B, which is the second reference apparatus, performs time synchronization with the master function unit 221A so as to function as a backup system in case of failure of the master function unit 221A, which is the first reference apparatus.

As depicted in FIG. 12, compared to the master function unit 121 depicted in FIG. 3, the master function unit 221B includes a processing unit 252 in place of the time synchronization unit 52, and also includes a plurality of communication ports 54. One or both of the communication unit 51 and the processing unit 252 is/are realized by a processing circuit including one or a plurality of processors for example. As one example, the storage unit 23 is a non-volatile memory included in such processing circuit. The communication port 54A is connected to the master function unit 221A, and the communication port 54B is connected to the switch apparatus 111B. The processing unit 252 includes a time synchronization unit 71, a detection unit 72, and an abnormality processing unit 73.

The time synchronization unit 71 performs time synchronization between the master function unit 221B to which it belongs and the master function unit 221A. In more detail, the time synchronization unit 71 transmits and receives the time synchronization information Ta between the master function unit 221A and the master function unit 221B. The time synchronization unit 71 then calculates the time difference between the time at the master function unit 221A and the time at the master function unit 221B and performs time synchronization with the master function unit 221A based on the calculated time difference.

As one example, the detection unit 72 of the master function unit 221B monitors second transmission information, which is information transmitted from the master function unit 221A and detects any abnormality in the content of the second transmission information (hereinafter also referred to as the “abnormality E2”). The abnormality E2 is an abnormality relating to the content of time synchronization information Ta, which is one example of the “second transmission information”. The time synchronization information Ta is at least one of a Sync message used for time synchronization and a follow-up message. Note that the time synchronization information Ta is not limited to a Sync message and a follow-up message, and may be another message used for time synchronization. The detection unit 72 transmits information indicating the detection result to the abnormality processing unit 73.

When the abnormality processing unit 73 has detected the abnormality E2, the abnormality processing unit 73 performs a stop process for stopping time synchronization on the vehicle-mounted network 201 that uses the time synchronization information Ta received from the master function unit 221A.

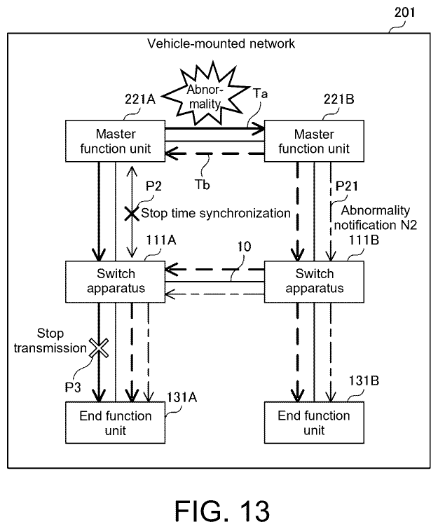

FIG. 13 depicts one example of a stop process performed by a master function unit and a switch apparatus in a vehicle-mounted communication system according to the second embodiment of the present disclosure.

As depicted in FIGS. 12 and 13, when the master function unit 221B has detected an abnormality E2 on the vehicle-mounted network 201, as one example the master function unit 221B transmits a notification indicating that it has detected the abnormality E2 (hereinafter also referred to as an “abnormality notification N2”) to the switch apparatus 111.

As a specific example, the abnormality processing unit 73 in the master function unit 221B may multicast the abnormality notification N2.

The switch apparatus 111B transmits the abnormality notification N2 received from the master function unit 221B to the switch apparatus 111A and the end function unit 131B. The switch apparatus 111A transmits the abnormality notification N2 received from the switch apparatus 111B to the end function unit 131A.

In this manner, the master function unit 221B performs a process P21 that notifies other vehicle-mounted apparatuses on the vehicle-mounted network 201 that the abnormality E2 has been detected.

As depicted in FIGS. 11, 12, and 13, when an abnormality E2 has been detected by the master function unit 221B, the switch apparatus 111A performs a stop process by the time synchronization unit 41, that is, a stop process P2 that stops time synchronization with the master function unit 221A. In more detail, after receiving the abnormality notification N2 from the master function unit 221B, the relay unit 21 of the switch apparatus 111A discards the time synchronization information Ta received from the master function unit 221A via the communication port 24A and does not store the time synchronization information Ta in the storage unit 23. As a result of this, the time synchronization information Ta is not outputted from the relay unit 21 to the time synchronization unit 41, and time synchronization between the switch apparatus 111A and the master function unit 221A is stopped.

When the abnormality E2 has been detected, the time synchronization unit 41 of the switch apparatus 111A transmits and receives the time synchronization information Tb to and from the master function unit 221B in place of the master function unit 221A. The time synchronization unit 41 then calculates the time difference between the time at the switch apparatus 111A to which it belongs and the time at the master function unit 221B, and performs time synchronization with the master function unit 221B based on the calculated time difference. Note that when the abnormality E2 has been detected by the detection unit 42 of the switch apparatus 111A to which the time synchronization unit 41 belongs, the time synchronization unit 41 may transmit and receive the time synchronization information Tb to and from the master function unit 221B in place of the master function unit 221A.

When the abnormality E2 has been detected, the switch apparatus 111A may perform a stop process P3 to stop transmission of the time synchronization information Ta to the end function unit 131. In more detail, as described above, after receiving the abnormality notification N2, the relay unit 21 discards the time synchronization information Ta that was received from the master function unit 221A via the communication port 24A and does not store the time synchronization information Ta in the storage unit 23. As a result of this, no data is transmitted from the relay unit 21 via the communication port 24D to the end function unit 131, and time synchronization between the end function unit 131 and the switch apparatus 111A stops.

### Flow of Operations

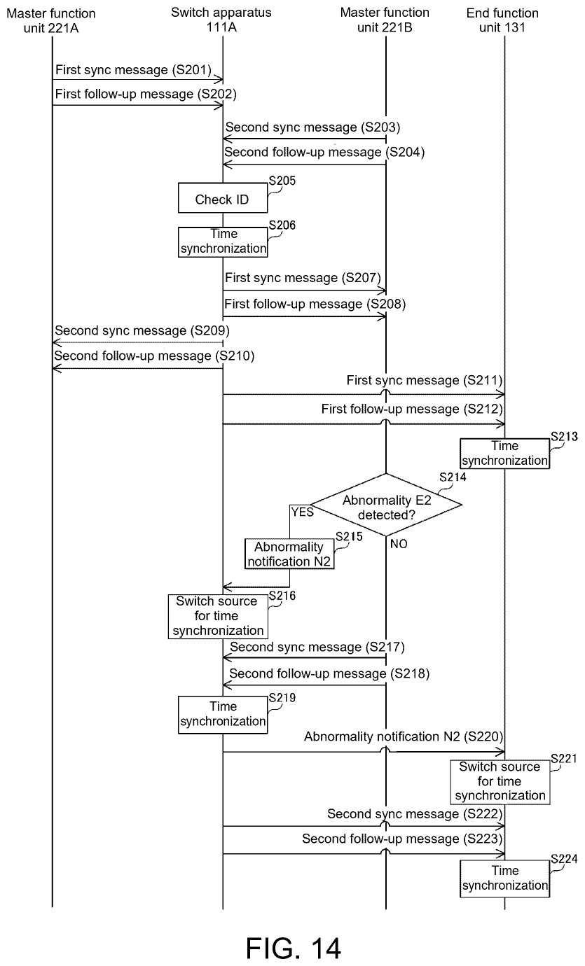

FIG. 14 depicts one example of a sequence of a process, which monitors time synchronization information and switches the time synchronization information, performed by a master function unit in the vehicle-mounted communication system according to the second embodiment of the present disclosure.

As depicted in FIG. 14, first, the master function unit 221A transmits a first Sync message to the switch apparatus 111A (step S201).

Next, the master function unit 221A transmits a first follow-up message including the transmission time of the first Sync message to the switch apparatus 111A (step S202).

The master function unit 221B then transmits a second Sync message to the switch apparatus 111A via the switch apparatus 111B (step S203).

Next, the master function unit 221B transmits a second follow-up message including the transmission time of the second Sync message via the switch apparatus 111B to the switch apparatus 111A (step S204).

After this, the switch apparatus 111A checks the domain ID attached to the header portion of each of the frames in which the first follow-up message is stored and the frame in which the second follow-up message is stored. The switch apparatus 111A then determines the Sync message and follow-up message to be used for time synchronization during normal operation by checking which of the two domain IDs that have been checked matches the normal domain ID. In the example depicted in FIG. 14, the Sync message and follow-up message to be used for time synchronization during normal operation are the first Sync message and the first follow-up message (step S205).

Next, the switch apparatus 111A performs time synchronization with the master function unit 221A based on the first Sync message and the first follow-up message (step S206).

The switch apparatus 111A then transmits the first Sync message received from the master function unit 221A to the master function unit 221B via the switch apparatus 111B (step S207).

The switch apparatus 111A then further includes the reception time of the first Sync message in the first follow-up message received from the master function unit 221A and transmits the resulting first follow-up message to the master function unit 221B (step S208).

After this, the switch apparatus 111A transmits the second Sync message received from the master function unit 221B to the master function unit 221A (step S209).

Next, the switch apparatus 111A further includes the reception time of the second Sync message in the second follow-up message received from the master function unit 221B and transmits the resulting second follow-up message to the master function unit 221A (step S210).

After this, the switch apparatus 111A transmits the first Sync message received from the master function unit 221A to the end function unit 131 (step S211).

Next, the switch apparatus 111A further includes the reception time of the first Sync message in the first follow-up message received from the master function unit 221A and transmits the resulting first follow-up message to the end function unit 131 (step S212).

After this, the end function unit 131 performs time synchronization with the switch apparatus 111A based on the first Sync message and the first follow-up message received from the switch apparatus 111A (step S213).

Next, the master function unit 221B performs a detection process to detect the abnormality E2. The detection process for the abnormality E2 is the same as the detection process for the abnormality E1 in step S103 depicted in FIG. 8 and described earlier (step S214).

After this, if the master function unit 221B has detected the abnormality E2 (“YES” in step S214), the master function unit 221B transmits an abnormality notification N2 via the switch apparatus 111B to the switch apparatus 111A (step S215).

Next, the switch apparatus 111A receives the abnormality notification N2 from the master function unit 221B and switches from performing time synchronization with the master function unit 221A to time synchronization with the master function unit 221B (step S216).

After this, the master function unit 221B transmits a second Sync message to the switch apparatus 111A via the switch apparatus 111B (step S217).

Next, the master function unit 221B transmits a second follow-up message including the transmission time of the second Sync message via the switch apparatus 111B to the switch apparatus 111A (step S218).

After this, the switch apparatus 111A performs time synchronization with the master function unit 221B based on the second Sync message and the second follow-up message received from the master function unit 221B (step S219).

Next, the switch apparatus 111A transmits the abnormality notification N2 received from the master function unit 221B to the end function unit 131 (step S220).

After this, the end function unit 131 receives the abnormality notification N2 from the switch apparatus 111A and switches from performing time synchronization with the master function unit 221A to time synchronization with the master function unit 221B (step S221).

Next, the switch apparatus 111A transmits the second Sync message received from the master function unit 221B to the end function unit 131 (step S222).

After this, the switch apparatus 111A transmits the second follow-up message received from the master function unit 221B to the end function unit 131 (step S223).

Next, the end function unit 131 performs time synchronization with the master function unit 221B based on the second Sync message and the second follow-up message received from the switch apparatus 111A (step S224).

On the other hand, if the master function unit 221B has not detected the abnormality E2 (“NO” in step S214), the master function unit 221B does not transmit the abnormality notification N2 described above.

In this way, if the switch apparatus 111A has detected an abnormality E2 relating to the master function unit 221A, the switch apparatus 111A switches the target of time synchronization from the master function unit 221A to the master function unit 221B. As a result of this, it is possible to perform time synchronization with the master function unit 221B, which makes it possible to achieve more stable time synchronization on the vehicle-mounted network 201.

### Alternative Example of Process Switching Time Synchronization Information

In the example described above, during normal operation of the switch

apparatus 111A, each of the master function units 221A and 221B will transmit time synchronization information to the switch apparatus 111A. In the following example, during normal operation, one out of the master function units 221A and 221B transmits time synchronization information to the switch apparatuses 111, and after an abnormality has occurred, the other out of the master function units 221A and 221B will transmit the time synchronization information to the switch apparatuses 111.

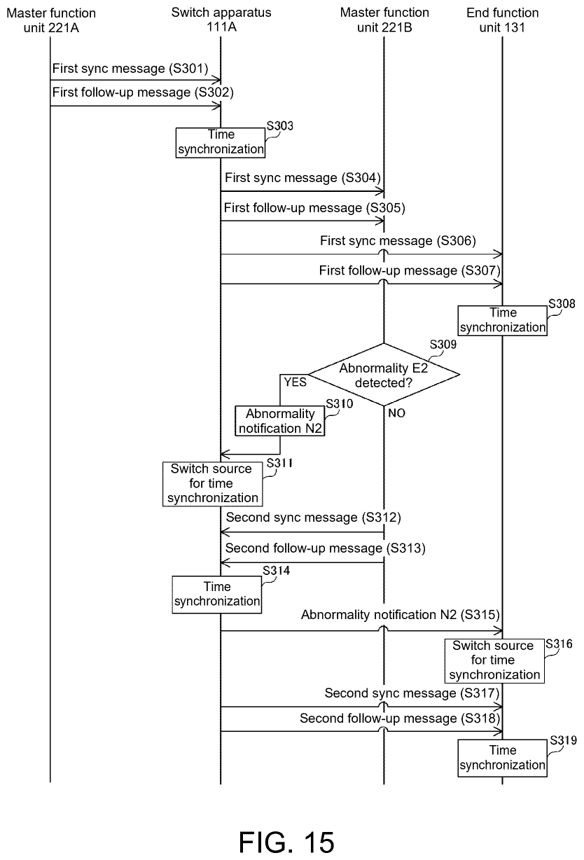

FIG. 15 depicts another example of the sequence of a process, which monitors the time synchronization information and switches between time synchronization information, performed by a master function unit in the vehicle-mounted communication system according to the second embodiment of the present disclosure.

As depicted in FIG. 15, first, the master function unit 221A transmits a first Sync message to the switch apparatus 111A (step S301).

Next, the master function unit 221A transmits a first follow-up message including the transmission time of the first Sync message to the switch apparatus 111A (step S302).

After this, the switch apparatus 111A performs time synchronization with

the master function unit 221A based on the first Sync message and the first follow-up message (step 303).

Next, the switch apparatus 111A transmits the first Sync message received from the master function unit 221A to the master function unit 221B (step S304).

After this, the switch apparatus 111A further includes the reception time of the first Sync message in the first follow-up message and transmits the resulting first follow-up message to the master function unit 221B (step S305).

Next, the switch apparatus 111A transmits the first Sync message received from the master function unit 221A to the end function unit 131 (step S306).

After this, the switch apparatus 111A further includes the reception time of the first Sync message in the first follow-up message received from the master function unit 221A and transmits the resulting message to the end function unit 131 (step S307).

Next, the end function unit 131 performs time synchronization with the switch apparatus 111A based on the first Sync message and the first follow-up message received from the switch apparatus 111A (step S308).

After this, the master function unit 221B performs a detection process for the abnormality E2 (step S309) in the same way as the process in step S214 depicted in FIG. 14 described above.

If the master function unit 221B has detected an abnormality E2 (“YES” in

step S309), the master function unit 221B transmits the abnormality notification N2 via the switch apparatus 111B to the switch apparatus 111A (step S310).

Next, the switch apparatus 111A receives the abnormality notification N2 from the master function unit 221B and switches from performing time synchronization with the master function unit 221A to time synchronization with the master function unit 221B (step S311).

After this, the master function unit 221B transmits a second Sync message to the switch apparatus 111A via the switch apparatus 111B (step S312).

Next, the master function unit 221B transmits a second follow-up message including the transmission time of the second Sync message via the switch apparatus 111B to the switch apparatus 111A (step S313).

After this, the switch apparatus 111A performs time synchronization with the master function unit 221B based on the second Sync message and the second follow-up message received from the master function unit 221B (step S314).

On the other hand, if the master function unit 221B has not detected the abnormality E2 (“NO” in step S309), the master function unit 221B does not transmit the abnormality notification N2 described above.

The processes in steps S315 to S319 depicted in FIG. 15 are the same as in steps S220 to S224 depicted in FIG. 14, respectively.

Each process (that is, each function) in the embodiments described above is realized by a processing circuit (circuitry) including one or a plurality of processors. Such processing circuit may be configured as an integrated circuit or the like in which one or a plurality of memories, various analog circuits, and various digital circuits are combined in addition to the one or plurality of processors. The one or plurality of memories store programs (instructions) that cause the one or more processors to execute the respective processes described above. The one or plurality of processors may execute the respective processes described above according to such programs that have been read from the one or plurality of memories, or may execute the processes described above according to a logic circuit designed in advance to execute such processes. The processors mentioned above may be any of a variety of processors that are suited to computer control, such as a CPU (Central Processing Unit), a GPU (Graphics Processing Unit), a DSP (Digital Signal Processor), an FPGA (Field Programmable Gate Array), and an ASIC (Application Specific Integrated Circuit). Note that the processors described above that are physically separated may cooperate with each other to execute the processes described above. As one example, processors installed in a plurality of physically separated computers may cooperate with each other via a network, such as a LAN (Local Area Network), a WAN (Wide Area Network), or the Internet, to execute the processes described above. The above programs may be installed into the memories mentioned above from an external server apparatus or the like via the network, or may be distributed having been stored on a recording medium such as a CD-ROM (Compact Disc Read Only Memory), a DVD-ROM (Digital Versatile Disc Read Only Memory), or a semiconductor memory and then installed from such recording medium into the memories.

All features of the embodiments disclosed here are exemplary and should not be regarded as limitations on the present disclosure. The scope of the present invention is indicated by the range of the patent claims, not the description given above, and is intended to include all changes within the meaning and scope of the patent claims and their equivalents.

1. A vehicle-mounted apparatus to be used on a vehicle-mounted network, comprising:
a time synchronization unit configured to calculate a time difference with another vehicle-mounted apparatus by transmitting and receiving time synchronization information, which is information for time synchronization between the vehicle-mounted apparatus and the other vehicle-mounted apparatus, and to perform time synchronization with the other vehicle-mounted apparatus based on the calculated time difference;
a detection unit configured to monitor first transmission information, which is information transmitted to the vehicle-mounted apparatus from the other vehicle-mounted apparatus, and to detect an abnormality in a content of the first transmission information; and
an abnormality processing unit configured to perform a stop process for stopping time synchronization on the vehicle-mounted network using the time synchronization information transmitted from the other vehicle-mounted apparatus when an abnormality has been detected by the detection unit.

2. The vehicle-mounted apparatus according to claim 1,
wherein the first transmission information is the time synchronization information.

3. The vehicle-mounted apparatus according to claim 1,
wherein the first transmission information indicates a source of reference information that serves as a basis for a time at the other vehicle-mounted apparatus.

4. The vehicle-mounted apparatus according to claim 2,
wherein the abnormality processing unit performs the stop process that notifies another vehicle-mounted apparatus, which calculates a time difference from the vehicle-mounted apparatus using the time synchronization information that is transmitted by the vehicle-mounted apparatus, that the abnormality has been detected.

5. The vehicle-mounted apparatus according to claim 1,
wherein the abnormality processing unit performs the stop process that stops the time synchronization by the time synchronization unit.

6. The vehicle-mounted apparatus according to claim 1,
wherein the abnormality processing unit performs the stop process that stops transmission of the time synchronization information to another vehicle-mounted apparatus that calculates a time difference from the vehicle-mounted apparatus using the time synchronization information transmitted by the vehicle-mounted apparatus.

7. The vehicle-mounted apparatus according to claim 1,
wherein a first reference apparatus, which is the other vehicle-mounted apparatus that performs time synchronization with the vehicle-mounted apparatus, and a second reference apparatus are provided on the vehicle-mounted network,
the second reference apparatus monitors second transmission information, which is information transmitted from the first reference apparatus to the second reference apparatus, and detects an abnormality relating to a content of the second transmission information, and
when an abnormality has been detected by the second reference apparatus, the time synchronization unit transmits and receives time synchronization information, which is information for time synchronization, with the second reference apparatus in place of the first reference apparatus, calculates a time difference from the second reference apparatus, and performs time synchronization with the second reference apparatus based on the calculated time difference.

8. The vehicle-mounted apparatus according to claim 1,
wherein a first reference apparatus, which is the other vehicle-mounted apparatus, and a second reference apparatus, are provided on the vehicle-mounted network, and
when an abnormality has been detected by the detection unit, the time synchronization unit transmits and receives time synchronization information, which is information for time synchronization, with the second reference apparatus in place of the first reference apparatus, calculates a time difference from the second reference apparatus, and performs time synchronization with the second reference apparatus based on the calculated time difference.

9. The vehicle-mounted apparatus according to claim 2,
wherein the time synchronization information is at least one of a Sync message used for time synchronization and a follow-up message.

10. A time synchronization method for a vehicle-mounted apparatus, the method comprising:
a step of calculating a time difference with another vehicle-mounted apparatus by transmitting and receiving time synchronization information, which is information for time synchronization between the vehicle-mounted apparatus and the other vehicle-mounted apparatus, and performing time synchronization with the other vehicle-mounted apparatus based on the calculated time difference;
a step of monitoring first transmission information, which is information transmitted to the vehicle-mounted apparatus from the other vehicle-mounted apparatus, and detecting an abnormality in a content of the first transmission information; and
a step of performing a stop process for stopping time synchronization on a vehicle-mounted network using the time synchronization information transmitted from the other vehicle-mounted apparatus when an abnormality has been detected.
